(19) United States
(12) Patent Application Publication
(10) Pub. No.: US 2018/0241140 A1
(43) Pub. Date: Aug. 23, 2018

(54) ADAPTER CARD

(71) Applicant: Shannon Systems Ltd., Shanghai (CN)

(72) Inventors: Xinglong WANG, Shanghai (CN); Xiaoyan CHEN, Shanghai (CN)

(21) Appl. No.: 15/807,829

(22) Filed: Nov. 9, 2017

(30) Foreign Application Priority Data
Feb. 17, 2017 (CN) 201710086293.3

(51) Int. Cl. H01R 12/70; G06F 13/40; G06F 13/42; G06F 1/20; H01R 12/72

(52) U.S. Cl. CPC H01R 12/7076; G06F 13/4081; G06F 13/4282; G06F 2213/3802; H01R 12/721; H01R 12/724; G06F 2213/0026; G06F 1/20

(57) ABSTRACT

An adapter card is provided, which is adapted to couple a storage device to a circuit board. The adapter card includes a card body, a first port, a second port and a first planar supporter. The first port is disposed on a surface of the card body. The first port is adapted to be coupled to the storage device. The second port is disposed on an edge of the card body. The second port is adapted to be coupled to the circuit board. An interface stander of the first port differs from an interface stander of the second port. The first planar supporter is disposed on the surface of the card body. When the storage device is connected to the first port, the first planar supporter abuts a first side of the storage device.

### CROSS REFERENCE TO RELATED APPLICATIONS

This Application claims priority of China Patent Application No. 201710086293.3, filed on Feb. 17, 2017, the entirety of which is incorporated by reference herein.

### BACKGROUND OF THE INVENTION

### Field of the Invention

The present invention relates to an adapter card, and in particular to an adapter card adapted to couple a storage device to a circuit board.

### Description of the Related Art

Conventional adapter cards are adapted to couple a storage device (such as Solid State Disk, SSD) to a circuit board. The adapter card includes a first port and a second port. The first port is adapted to be coupled to the storage device. The second port is adapted to be coupled to the circuit board. Conventionally, the storage device tightly fits the first port to be coupled to the adapter card. However, currently, the storage device utilizes a metal housing to improve heat-dissipation efficiency, and the weight of the storage device is increased. The conventional adapter card cannot support the storage device, and the storage device tends to be separated from the first port.

### BRIEF SUMMARY OF THE INVENTION

An adapter card is provided, which is adapted to couple a storage device to a circuit board. The adapter card includes a card body, a first port, a second port and a first planar supporter. The first port is disposed on a surface of the card body. The first port is adapted to be coupled to the storage device. The second port is disposed on an edge of the card body. The second port is adapted to be coupled to the circuit board. The interface stander of the first port differs from the interface stander of the second port. The first planar supporter is disposed on the surface of the card body. When the storage device is connected to the first port, the first planar supporter abuts the first side of the storage device.

In one embodiment, the first port is connected to the storage device in a first direction. The second port is connected to the circuit board in a second direction. The first direction is perpendicular to the second direction. The first planar supporter extends in the first direction.

In one embodiment, the first planar supporter is located between the first port and the second port in the second direction.

In one embodiment, the adapter card further comprises a plurality of first fasteners. The card body has a plurality of first holes. The first fasteners respectively pass through the first holes to be affixed to the storage device.

In one embodiment, the adapter card further comprises a plurality of second fasteners. The first planar supporter has a plurality of second holes. The second fasteners respectively pass through the second holes to be affixed to the storage device.

In one embodiment, the adapter card further comprises a second planar supporter. The second planar supporter is disposed on the surface of the card body and faces the first planar supporter. The second planar supporter corresponds to a second side of the storage device. The first side is opposite to the second side.

In one embodiment, the adapter card further comprises a plurality of third fasteners. The second planar supporter has a plurality of third holes. The third fasteners respectively pass through the third holes to be affixed to the storage device.

In one embodiment, the card body has a heat-dissipation opening area. When the storage device is connected to the first port, the heat-dissipation opening area corresponds to a first surface of the storage device, and heat generated by the storage device is removed through the heat-dissipation opening area.

In one embodiment, the first port is a U.2 port. The second port is a PCIE port. The storage device is a SSD. The storage device comprises a metal housing. The first planar supporter abuts the first side of the metal housing.

In one embodiment, an adapter card is provided, which is adapted to couple a storage device to a circuit board. The adapter card includes a card body, a first port and a second port. The card body has a heat-dissipation opening area. The first port is disposed on a surface of the card body. The first port is adapted to be coupled to the storage device. The second port is disposed on an edge of the card body. The second port is adapted to be coupled to the circuit board. An interface stander of the first port differs from an interface stander of the second port. When the storage device is connected to the first port, the heat-dissipation opening area corresponds to a first surface of the storage device, and heat generated by the storage device is removed through the heat-dissipation opening area.

In one embodiment, the adapter card further comprises a plurality of first fasteners. The card body has a plurality of first holes. The first fasteners respectively pass through the first holes to be affixed to the storage device.

In one embodiment, the heat-dissipation opening area has a plurality of heat-dissipation openings, and the heat-dissipation openings are arranged in a matrix.

In the embodiments of the invention, the first planar supporter is under the storage device and supports the storage device. The weight of the storage device is supported by the first planar supporter, and the storage device is prevented from becoming separated from the first port. Additionally, when the storage device is connected to the first port, the storage device is guided by the first planar supporter to be smoothly connected to the first port. Additionally, the fasteners of the embodiment of the invention further affix and support the storage device.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1A is an exploded view of an adapter card of a first embodiment of the invention;

FIG. 1B is a perspective view of the adapter card of the first embodiment of the invention;

FIG. 1C is a block diagram of the adapter card of the first embodiment of the invention;

FIG. 2 is an exploded view of an adapter card of a second embodiment of the invention;

FIG. 3A is an exploded view of an adapter card of a third embodiment of the invention;

FIG. 3B is a perspective view of the adapter card of the third embodiment of the invention;

FIG. 4A is an exploded view of an adapter card of a fourth embodiment of the invention; and

FIG. 4B is a perspective view of the adapter card of the fourth embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

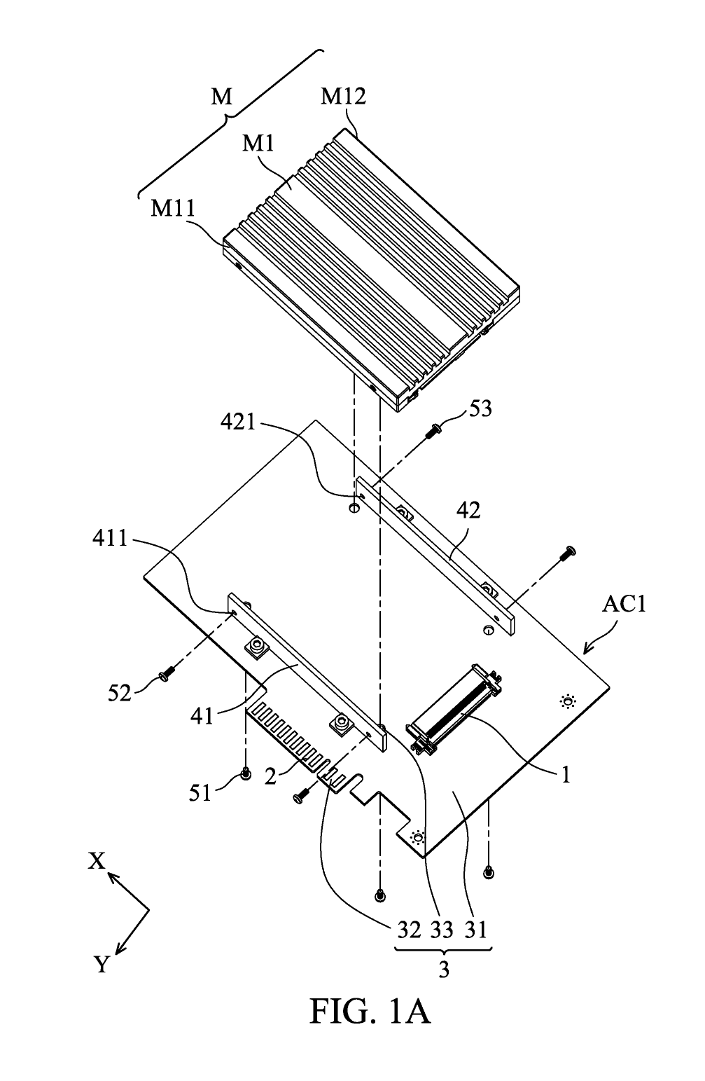

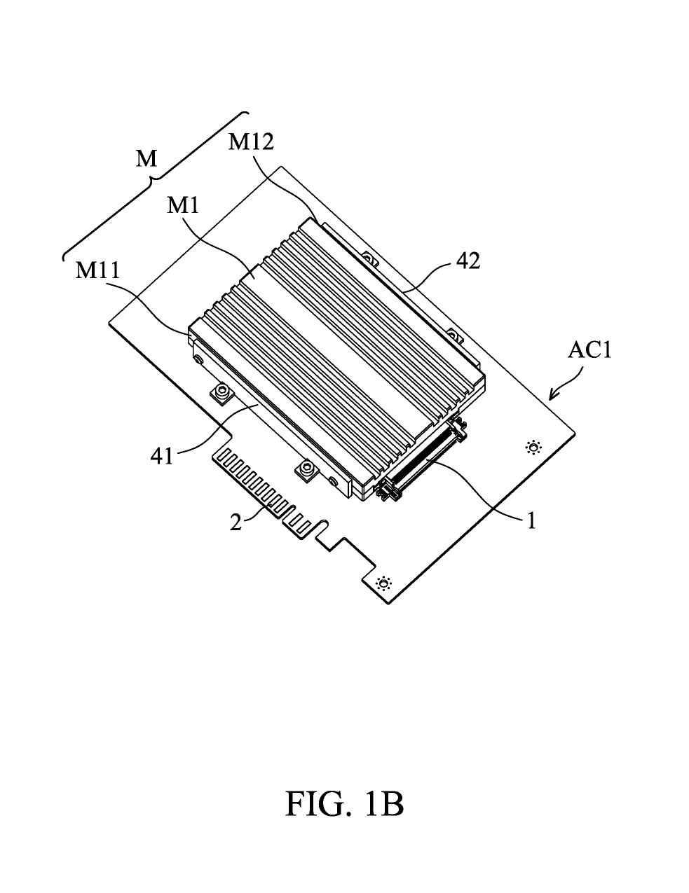

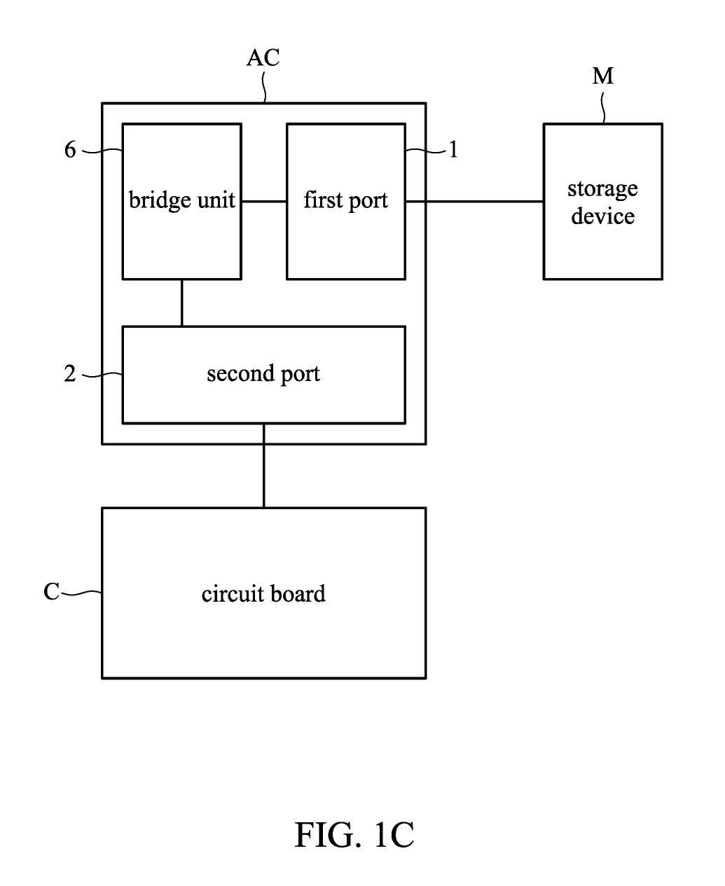

FIGS. 1A and 1B show an adapter card AC1 of a first embodiment of the invention. The adapter card AC1 is adapted to couple a storage device M to a circuit board C (not shown). The adapter card AC1 includes a card body 3, a first port 1, a second port 2 and a first planar supporter 41. The first port 1 is disposed on a surface 31 of the card body 3. The first port 1 is adapted to be coupled to the storage device M. The second port 2 is disposed on an edge 32 of the card body 3. The second port 2 is adapted to be coupled to the circuit board C. An interface stander of the first port 1 differs from an interface stander of the second port 2. The first planar supporter 41 is disposed on the surface 31 of the card body 3. When the storage device M is connected to the first port 1, the first planar supporter 41 abuts a first side M11 of the storage device M.

In the first embodiment of the invention, the first planar supporter 41 is under the storage device M and supports the storage device M. The weight of the storage device M is supported by the first planar supporter 41, and the storage device M is prevented from becoming separated from the first port 1. Additionally, when the storage device M is connected to the first port 1, the storage device M is guided by the first planar supporter 41 to be smoothly connected to the first port 1.

With reference to FIGS. 1A and 1B, in one embodiment, the first port 1 is a U.2 port, which is compatible with SATA (Serial Advanced Technology Attachment), SAS (Serial Attached SCSI) and SATA E (SATA Express) standers. The second port 2 is a PCIE (Peripheral Component Interconnect Express) port. The storage device M is a SSD (Solid State Disk). The storage device M comprises a metal housing M1. The first planar supporter 41 abuts the first side M11 of the metal housing M1. However, the disclosure is not meant to restrict the invention. The first port 1 and the second port 2 can be ports of other standers.

With reference to FIG. 1C, the adapter card AC1 comprises a bridge unit 6. The bridge unit 6 is coupled to the first port 1 and the second port 2. The first port 1 is coupled to the storage device M. The second port 2 is coupled to the circuit board C.

With reference to FIGS. 1A and 1B, in one embodiment, the first port 1 is connected to the storage device M in a first direction X. The second port 2 is connected to the circuit board in a second direction Y. The first direction X is perpendicular to the second direction Y. The first planar supporter 41 extends in the first direction X. The first planar supporter 41 is located between the first port 1 and the second port 2 in the second direction Y.

With reference to FIGS. 1A and 1B, in one embodiment, the adapter card AC1 further comprises a plurality of first fasteners 51. The card body 3 has a plurality of first holes 33. The first fasteners 51 respectively pass through the first holes 33 to be affixed to the storage device M (in this embodiment, the first fasteners 51 are affixed to a first surface M13 of the storage device M). The first fasteners 51 further affix and support the storage device M.

With reference to FIGS. 1A and 1B, in one embodiment, the adapter card AC1 further comprises a plurality of second fasteners 52. The first planar supporter 41 has a plurality of second holes 411. The second fasteners 52 respectively pass through the second holes 411 to be affixed to the first side M11 of the storage device M. The second fasteners 52 further affix and support the storage device M.

With reference to FIGS. 1A and 1B, in one embodiment, the adapter card AC1 further comprises a second planar supporter 42. The second planar supporter 42 is disposed on the surface 31 of the card body 3 and faces the first planar supporter 41. The second planar supporter 42 corresponds to a second side M12 of the storage device M. The first side M11 is opposite to the second side M12. Similarly, when the storage device M is connected to the first port 1, the storage device M is guided by the second planar supporter 42 to be smoothly connected to the first port 1.

In one embodiment, the adapter card AC1 further comprises a plurality of third fasteners 53. The second planar supporter 42 has a plurality of third holes 421. The third fasteners 53 respectively pass through the third holes 421 to be affixed to the second side M12 of the storage device M. The third fasteners 53 further affix and support the storage device M.

In the embodiments above, according to different affixing requirement, the storage device M can be affixed only by the first fasteners 51, only by the second fasteners 52, or only by the third fasteners 53. In another embodiment, the storage device M can also be affixed only by the second fasteners 52 and the third fasteners 53. The disclosure is not meant to restrict the invention.

In the embodiment, the first planar supporter 41 and the second planar supporter 42 provide vertical movement restriction for the storage device M. There is no additional metal plate connecting the first planar supporter 41 to the second planar supporter 42. Therefore, there is no additional metal plate covering the storage device M, and the heat-dissipation effect of the storage device M is improved.

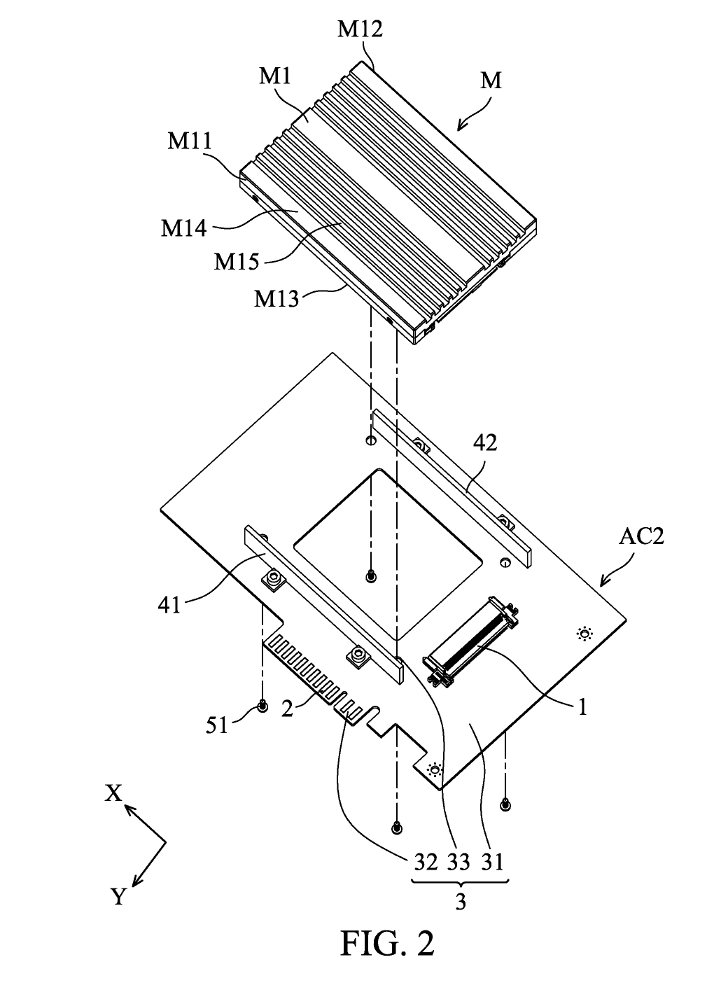

FIG. 2 shows an adapter card AC2 of a second embodiment of the invention. The card body 3 has a heat-dissipation opening area 34. When the storage device M is connected to the first port 1, the heat-dissipation opening area 34 corresponds to a first surface M13 of the storage device M, and the heat generated by the storage device is removed through the heat-dissipation opening area 34 from the first surface M13. The heat-dissipation opening area 34 improves the heat dissipation efficiency of the adapter card AC2. In this embodiment, the heat-dissipation opening area 34 is one single rectangular opening, and the first holes 33 are arranged around the heat-dissipation opening area 34.

In the second embodiment, only the first fasteners 51 are utilized to affix the storage device M. However, the disclosure is not meant to restrict the invention.

In one embodiment, the storage device M includes heat-dissipation structures M15 (for example, heat-dissipation fins). The heat-dissipation structures M15 are formed on a second surface M14 of the storage device M. The second surface M14 is opposite to the first surface M13. In one embodiment, the storage device M further includes a controller (not shown). The controller is the major heat source of the storage device M. The controller faces the second surface M14. Therefore, the heat-dissipation efficiency of the adapter card is improved. In one embodiment, there is no heat-dissipation structure formed on the first surface M13. The disclosure is not meant to restrict the invention.

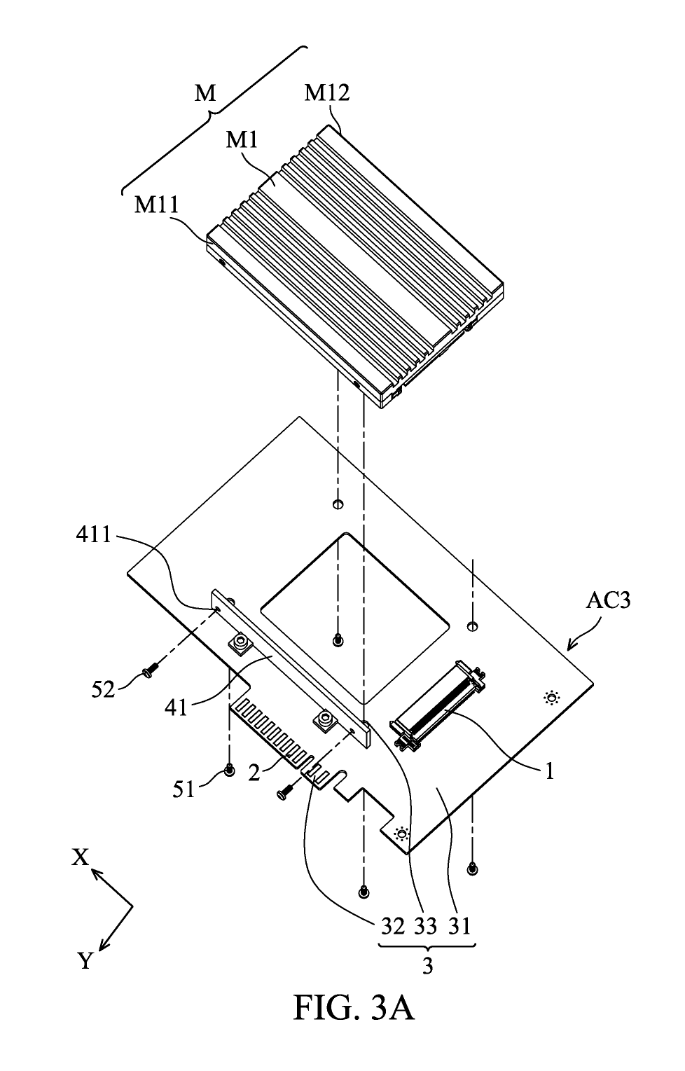

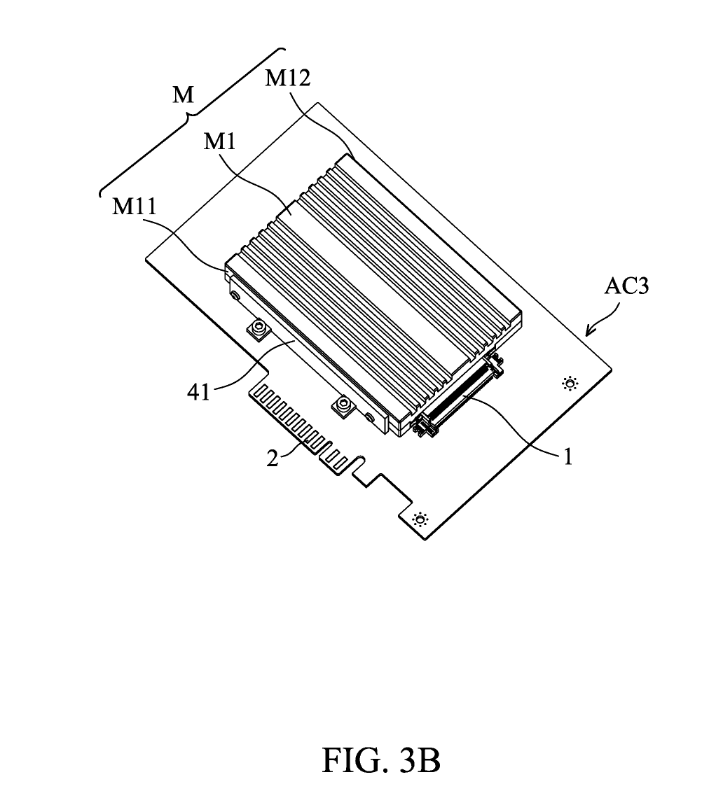

FIGS. 3A and 3B show an adapter card AC3 of a third embodiment of the invention. In the third embodiment, the second planar supporter 42 is omitted, and the storage device M is supported merely by the first planer supporter 41.

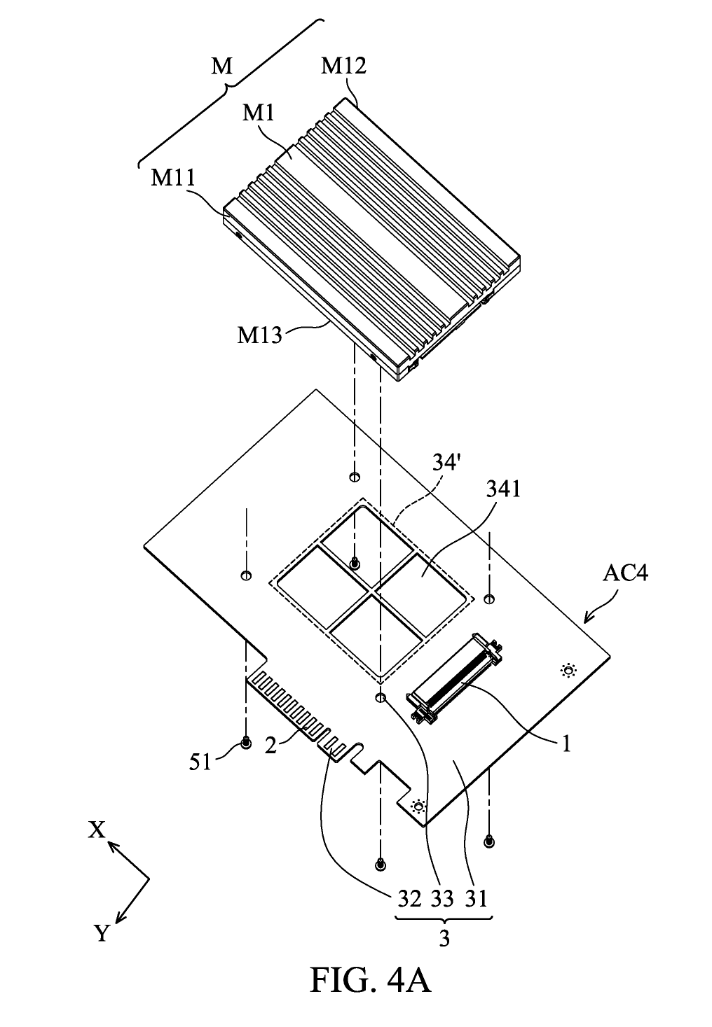

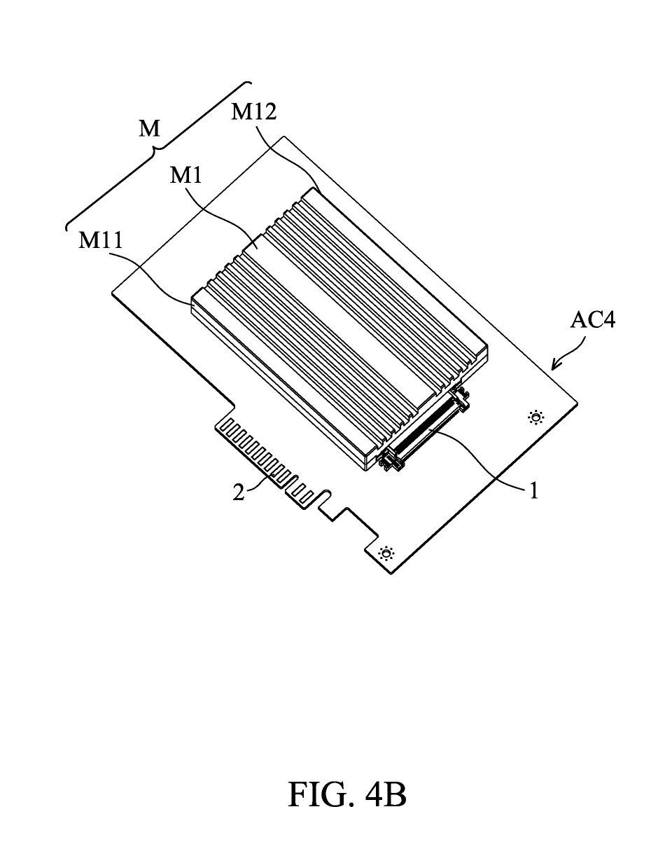

FIGS. 4A and 4B show an adapter card AC4 of a fourth embodiment of the invention, which is adapted to couple a storage device M to a circuit board C (not shown). The adapter card AC4 includes a card body 3, a first port 1 and a second port 2. The card body 3 has a heat-dissipation opening area 34′. The first port 1 is disposed on a surface 31 of the card body 3. The first port 1 is adapted to be coupled to the storage device M. The second port 2 is disposed on an edge 32 of the card body 3. The second port 32 is adapted to be coupled to the circuit board C. An interface stander of the first port 1 differs from an interface stander of the second port 2. When the storage device M is connected to the first port 1, the heat-dissipation opening area 34′ corresponds to a first surface M13 of the storage device M, and the heat generated by the storage device M is removed through the heat-dissipation opening area 34′ from the first surface M13. In this embodiment, the heat-dissipation opening area 34′ has a plurality of heat-dissipation openings 341, and the heat-dissipation openings 341 are arranged in a matrix.

With reference to FIGS. 4A and 4B, similar to the embodiments above, the adapter card AC4 includes a plurality of first fasteners 51. The card body 3 has a plurality of first holes 33. The first fasteners 51 respectively pass through the first holes 33 to be affixed to the storage device M.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term).

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An adapter card, adapted to couple a storage device to a circuit board, comprising:
a card body;
a first port, disposed on a surface of the card body, wherein the first port is adapted to be coupled to the storage device;
a second port, disposed on an edge of the card body, wherein the second port is adapted to be coupled to the circuit board, and an interface stander of the first port differs from an interface stander of the second port; and
a first planar supporter, disposed on the surface of the card body, wherein when the storage device is connected to the first port, the first planar supporter abuts a first side of the storage device.

2. The adapter card as claimed in claim 1, wherein the first port is connected to the storage device in a first direction, the second port is connected to the circuit board in a second direction, the first direction is perpendicular to the second direction, and the first planar supporter extends in the first direction.

3. The adapter card as claimed in claim 2, wherein the first planar supporter is located between the first port and the second port in the second direction.

4. The adapter card as claimed in claim 3, further comprising a plurality of first fasteners, the card body has a plurality of first holes, the first fasteners respectively pass through the first holes to be affixed to the storage device.

5. The adapter card as claimed in claim 3, further comprising a plurality of second fasteners, the first planar supporter has a plurality of second holes, the second fasteners respectively pass through the second holes to be affixed to the storage device.

6. The adapter card as claimed in claim 3, further comprising a second planar supporter, the second planar supporter is disposed on the surface of the card body and faces the first planar supporter, the second planar supporter corresponds to a second side of the storage device, and the first side is opposite to the second side.

7. The adapter card as claimed in claim 6, further comprising a plurality of third fasteners, the second planar supporter has a plurality of third holes, the third fasteners respectively pass through the third holes to be affixed to the storage device.

8. The adapter card as claimed in claim 1, wherein the card body has a heat-dissipation opening area, and when the storage device is connected to the first port, the heat-dissipation opening area corresponds to a first surface of the storage device, and heat generated by the storage device is removed through the heat-dissipation opening area.

9. The adapter card as claimed in claim 1, wherein the first port is a U.2 port, the second port is a PCIE port, the storage device is a SSD, the storage device comprises a metal housing, and the first planar supporter abuts the first side of the metal housing.

10. An adapter card, adapted to couple a storage device to a circuit board, comprising:
a card body, having a heat-dissipation opening area;
a first port, disposed on a surface of the card body, wherein the first port is adapted to be coupled to the storage device; and
a second port, disposed on an edge of the card body, wherein the second port is adapted to be coupled to the circuit board, and an interface stander of the first port differs from an interface stander of the second port, and when the storage device is connected to the first port, the heat-dissipation opening area corresponds to a first surface of the storage device, and heat generated by the storage device is removed through the heat-dissipation opening area.

11. The adapter card as claimed in claim 10, further comprising a plurality of first fasteners, the card body has a plurality of first holes, the first fasteners respectively pass through the first holes to be affixed to the storage device.

12. The adapter card as claimed in claim 10, wherein the heat-dissipation opening area has a plurality of heat-dissipation openings, and the heat-dissipation openings are arranged in a matrix.
